(19) United States
(12) Patent Application Publication
(10) Pub. No.: US 2008/0254239 A1
(43) Pub. Date: Oct. 16, 2008

(54) Method for Preparation of Thermally Sensitive Recording Medium

(75) Inventors: Naoki Negishi, Tokyo (JP); Mizuho Shimoyama, Tokyo (JP); Akiharu Fujii, Tokyo (JP); Koichi Yanai, Tokyo (JP); Katsuto Ohse, Tokyo (JP)

Correspondence Address: FLYNN THIEL BOUTELL & TANIS, P.C., 2026 RAMBLING ROAD, KALAMAZOO, MI, 49008-1631, US

(73) Assignee: NIPPON PAPER INDUSTRIES CO., LTD., Tokyo (JP)

(21) Appl. No.: 11/663,251

(22) PCT Filed: Aug. 5, 2005
(86) PCT No.: PCT/JP05/14796

§ 371 Date: Mar. 16, 2007

(30) Foreign Application Priority Data
Sep. 30, 2004 (JP) 2004-288381

(51) Int. Cl. B41M 3/12; B41M 5/40

(52) U.S. Cl. 428/32.6; 427/150

(57) ABSTRACT

A thermally sensitive recording medium characterized to be superior in writing aptitude, printing aptitude, causes less head debris, possesses good water resistance, causes less sticking and is excellent in preservative stability of developed color in nature environment such as heat, water, humid or light, to sebum when handled with hand, oils, plasticizers and solvents can be obtained by following method, that is, a method for preparation of a thermally sensitive recording medium possessing a coating layer formed by applying a coating (A) containing a binder and a coating (B) containing a crosslinking agent on a thermally sensitive recording layer, which is formed on a substrate, and said thermally sensitive recording layer contains a colorless or pale colored electron donating leuco dye and an electron accepting color developing agent comprising, forming an over coating layer by applying said coating (A) and coating (B) separately in accordance with a curtain coating method, wherein the formation of the over coating layer is comprising, after applying one coating, applying another coating in accordance with a curtain coating method without having a drying process between.

### FIELD OF THE INVENTION

The present invention relates to a method for preparation of thermally sensitive recording medium utilizing a color developing reaction of an electron donating leuco dye and an electron accepting color developing agent.

### BACKGROUND OF THE INVENTION

In general, a thermally sensitive recording medium having a thermally sensitive recording layer containing an electron accepting color developing agent that develops color under heating with a colorless or pale colored electron donating leuco dye as main components is put into practical use extensively. A thermal printer incorporated with a thermal head or the like is used for recording on the thermally sensitive recording medium. Such a thermally sensitive recording method has features in that the method produces no noise during recording, requires no developing or fixing, is maintenance-free, employs relatively inexpensive and compact instruments, and provides very clear color development compared with other conventional recording methods in practical use. Thus, the thermally sensitive recording method is used extensively in a facsimile or computer field, for various measuring instruments, labels, tickets and the like with development of information industry.

Along with the extension of uses, variety and high diversification of recording devices are progressed and required quality to a thermally sensitive recording medium is becoming higher level. For example, writing aptitude or printing aptitude, head debris and chemical resistance are required, further, preservative stability of developed color to nature environment such as water, humid or light, to sebum, when handled with hand, oils, plasticizers and solvents. Further, remarkable deterioration or discoloring of density of developed image by contact with sebum component or a plasticizer (DOP or DOA) contained in wrapping film such as poly vinyl chloride film are still serious problems.

Up to this time, for the purpose to improve preservative stability of developed image, a method to coat aqueous emulsion of a resin having film forming ability and chemical resistance on a thermally sensitive recording layer or a method to coat water soluble polymer compound such as polyvinyl alcohol are proposed. For example, in JPA H3-61077 publication, a method to provide preservative stability of developed color by forming an over coating layer using a coating prepared by mixing polyvinyl alcohol and a curing agent (crosslinking agent) is proposed. However, since the curing agent (crosslinking agent), which is added for the purpose to provide water resistance progresses crosslinking reaction in a coating of the over coating layer, viscosity of the coating becomes higher by time lapse and finally becomes gelling, and causes problems in productivity and workability.

Further, in JPA H7-314914 publication, a method to form an over coating layer by coating and drying a self bridgeable acrylic resin is proposed. By this method, although the pot life of the self bridgeable acrylic resin is good, the price of it is relatively high, therefore this method is not desirable from the view point of preparation cost. Further, when compared with polyvinyl alcohol, the softening point of acrylic resin is relatively low, it has problems to causes head debris or sticking at recording process. Thus, the thermally sensitive recording medium, which satisfies quality, productivity and workability simultaneously is not found out yet.

### DISCLOSURE OF THE INVENTION

Considering above mentioned circumstances, the object of the present invention is to provide a method for preparation of thermally sensitive recording medium with an over coating layer, which is characterized to obtain a quality superior in writing aptitude or printing aptitude, causing less head debris, possessing good water resistance, causing less sticking and excellent in preservative stability of developed color in nature environment such as heat, water, humid or light, to sebum when handled with hand, oils, plasticizers and solvents.

The inventors of the present invention carried out strictly an investigation to dissolve above mentioned object, and found out that a method for preparation of a thermally sensitive recording medium possessing a coating layer formed by applying a coating (A) containing a binder and a coating (B) containing a crosslinking agent on a thermally sensitive recording layer, which is formed on a substrate, and said thermally sensitive recording layer contains a colorless or pale colored electron donating leuco dye and an electron accepting color developing agent comprising, forming an over coating layer by applying said coating (A) and coating (B) separately in accordance with a curtain coating method, wherein the formation of the over coating layer is comprising, after applying one coating, applying another coating in accordance with a curtain coating method without having a drying process between can dissolve the object and accomplished the present invention.

### PREFERRED EMBODIMENT OF THE INVENTION

The present invention will be illustrated more specifically and more in detail.

The present invention is a method for preparation of a thermally sensitive recording medium possessing a coating layer formed by applying a coating (A) containing a binder and a coating (B) containing a crosslinking agent on a thermally sensitive layer formed on a substrate, which contains a colorless or pale colored electron donating leuco dye and an electron accepting color developing agent comprising, forming an over coating layer by applying the coating (A) and the coating (B) separately in accordance with curtain coating method, wherein the formation of said over coating layer is comprising, after applying one coating, applying another coating in accordance with curtain coating method without having a drying process between. Thus, the thermally sensitive recording medium having an excellent quality can be obtained. Further, it is desirable after applying either coating (A) or coating (B) by curtain coating method to apply another coating within 1.0×10⁻⁴ seconds or more and shorter than 5.0 seconds so that to form an over coating layer.

In the method for preparation of a thermally sensitive recording medium of the present invention, the term of “curtain coating method” means the method to apply a coating without contact to a substrate by flowing down a coating freely, for example, public known method such as slide curtain coating method, slit curtain coating method or slot curtain coating method can be used, however, not restricted to them. And, regarding applying conditions such as concentration of a coating, applying speed, width of curtain film or angle of flowing down, it is desirable to adjust to a curtain coater to be used.

In particular, the method for preparation of the present invention is very effective method compared with the case to prepare a thermally sensitive recording medium for the purpose to provide printing aptitude, not to cause head debris and to possess good water resistance by mixing a crosslinking agent to a coating of the over coating layer, which is mainly composed of a binder. The coating used for an over coating layer prepared by mixing a binder and a crosslinking agent, has problems to increase viscosity or gelling, because the reaction of the binder with the crosslinking agent progresses by time lapse. Therefore, since further problems, for example, preparation of a thermally sensitive recording medium having stabilized quality is difficult or the pot life of a coating is remarkably short occurs, improvement of productivity or workability is desired.

On the contrary, in the present invention, a coating (A) containing a binder and a coating (B) containing a crosslinking agent are not mixed. After applying either coating (A) or coating (B), another coating is applied not having drying process, then dried and form an over coating layer. That is, after applying a coating (A) containing a binder and a coating (B) containing a crosslinking agent by wet on wet process, then dried and form an over coating layer, therefore, the problems to increase viscosity or gelling by time lapse do not occur. Therefore, the problem of workability caused by difficulty of preparation of a thermally sensitive recording medium having stabilized quality or by remarkable short pot life of a coating does not occur.

Further, the reason why excellent effect can be obtained in quality is not clear, however, guessed as follows. When an over coating layer is prepared by the method of the present invention using a coating (A) containing a binder and a coating (B) containing a crosslinking agent, since the viscosity of coatings mixed on the surface of a substrate increases by crosslinking reaction, penetration to a substrate is obstructed. That is, it is considered that this over coating layer exists in a state that a binder and a crosslinking agent are locally existing on the surface layer of the thermally sensitive recording medium, crosslinking reaction is promoted and forms very strong over coating layer.

Consequently, since strength, water resistance and oil resistance of the over coating layer are remarkably improved, it is considered that unexpected excellent effects are brought, namely, prevention of coloring by solvent when written by an oily marking pen, prevention of removal of a coating layer at printing process, prevention of formation of head debris and protection of broking caused by elution of binder contained in over coating layer by water or by humid. Further, since the coating layer formed by promotion of crosslinking reaction has good heat resistance, a big effect to suppress the problem caused by sticking of a binder or other components, which is fused by heat of a thermal head, to the thermal head. Further, regarding preservative stability of developed color to nature environment such as water, humid or light, to sebum, when handled with hand, oils, plasticizers and solvents, it is considered that because the over coating layer, which is formed very strongly by promotion of crosslinking reaction, prevents discoloration of developed image by an external factor.

In the present invention, by forming an over coating layer by a curtain coating method, since an uniform coating layer can be formed, desired quality can be obtained by lower coating amount compared with an over coating layer formed by a conventional coating method such as bar blade coating method or air knife coating method. That is, since a protecting layer of thinner film thickness can be obtained, heat of a thermal printer can be effectively conducted to a thermally sensitive recording layer. Consequently, not only high recording density can be obtained, but also advantageous from the view point of cost can be obtained.

In the present invention, by forming an over coating layer, that is, after applying either a coating (A) containing a binder or a coating (B) containing a crosslinking agent, another coating is applied without having a drying process between within 1.0×10⁻⁴ seconds or more and shorter than 5.0 seconds, desirably within 1.0 second and more desirably within 0.1 second, a binder and a crosslinking agent can be exist locally on the surface layer of the thermally sensitive recording medium, therefore, very strong over coating layer can be formed.

When the time to contact the coating (A) and the coating (B) is over than 5 seconds, the coating applied to the substrate penetrates to the substrate side, it is not possible to form an over coating layer in the condition of wet on wet, quality of sufficient printing aptitude and plasticizer resistance can not be obtained. Further, as the technical level at the filing of the present application, maximum coating speed of a curtain coater is approximately 2000 m/min, and to make fall down two curtain films without contacting each other, since it is necessary to have more than 1 cm distance between said two curtain films, it is difficult to make a time till the coating (A) and the coating (B) contact on the substrate less than 10×10⁻⁴ sec. while, the time till the coating (A) and the coating (B) contact on the substrate is calculated from following formula. [symbol] distance between curtain films (m)/coating speed (m/min)×60

[symbol]

In preparation of the thermally sensitive recording medium of the present invention, when an over coating layer is formed by applying two coatings in order of the coating (A) containing a binder and the coating (B) containing a crosslinking agent, a thermally sensitive recording medium characterized to have especially strong surface strength, in other wards, to have excellent sticking resistance can be obtained. On the contrary, when an over coating layer is formed by applying two coatings in order of the coating (B) containing a crosslinking agent and the coating (A) containing a binder, a thermally sensitive recording medium characterized to have especially high surface barrier ability, in other wards, to have excellent plasticizer resistance can be obtained. The characteristic of the former is based on the condition that the crosslinking agent is largely exists on the surface of the over coating layer, and the characteristic of the latter is based on the condition that the binder is largely exists on the surface of the over coating layer.

Examples of each materials used in the present invention will be mentioned as follows, and a binder or a crosslinking agent can be used not only in the over coating layer, but also in other layers such as thermally sensitive recording layer or various coating layers formed when need is arisen.

As a binder to be used in the present invention, it is required to possess a hydroxyl group and/or carboxyl group, completely saponified polyvinyl alcohol having a degree of polymerization of 200 to 1,900, partially saponified polyvinyl alcohol, acetoacetyl polyvinylalcohol, carboxyl denatured polyvinyl alcohol, amide denatured polyvinyl alcohol, sulfonic acid denatured polyvinyl alcohol, butyral denatured polyvinyl alcohol, olefin denatured polyvinyl alcohol, nitlile denatured polyvinyl alcohol, pyrroridone denatured polyvinyl alcohol, silicone denatured polyvinyl alcohol, other denatured polyvinyl alcohol, hydroxyethylcellulose, methylcellulose, ethylcellulose, carboxy methylcellulose, styrene-maleic anhydride copolymer, styrene-butadiene copolymer, cellulose derivative such as ethylcellulose or acetylcellulose, casein, gum arabic, starch oxide, etherificated starch, dialdehyde starch, esterficated starch, polyvinyl chloride, polyvinyl acetate, polyacrylamide, polyacrylate, polyvinyl butyral, polystyrol and a copolymer thereof, polyamide resin, silicon resin, petroleum resin, terpene resin, ketone resin and cumarone resin can be mentioned. Those high molecular weight substances can be used by: dissolving in a solvent such as water, alcohol, a ketone, an ester, or a hydrocarbon; or emulsifying or dispersing as a paste in water or another medium. Both methods can be used together in accordance with required quality.

As a crosslinking agent to be used in the present invention, glyoxal, methylolmelamine, melamine formaldehyde resin, polyamideamine-epichlorohydrine, potassium peroxosulfate, ammonium peroxosulfate, sodium peroxosulfate, iron(III)chloride, magnesium chloride, borax, boric acid, alum, ammonium chloride, denatured polyamine or amide resins can be mentioned.

As a specific example of epichlorohydrine resins, polyamide epichlorohydrine resin or polyamine epichlorohydrine resin can be mentioned and these compounds can be used alone or together with. And, as amine that exists in main chain of epichlorohydrine resins, from primary to tertiary amine can be mentioned and not restricted. Further, regarding cationated degree and molecular weight, less than 5 meq/g·solid (measured at pH7) and over than 500,000 molecular weight is desirable. As a specific example, Sumirez Resin 650(30) (product of Sumitomo Chemical), Sumirez Resin 675A (product of Sumitomo Chemical), Sumirez Resin 6615 (product of Sumitomo Chemical), WS4002 (product of Seiko PMC), WS4024 (product of Seiko PMC), WS4046 (product of Seiko PMC), WS4010 (product of Seiko PMC) and CP8970 (product of Seiko PMC) can be mentioned.

As a denatured polyamine/amide resins, polyalkylenpolyamine such as polyamide urea resins or polyethyleneimine can be mentioned, and as a specific example, Sumirez Resin 302 (product of Sumitomo Chemical), Sumirez Resin 712 (product of Sumitomo Chemical), Sumirez Resin 703 (product of Sumitomo Chemical), Sumirez Resin 636 (product of Sumitomo Chemical), Sumirez Resin SPI-100 (product of Sumitomo Chemical), Sumirez Resin SPI-102A (product of Sumitomo Chemical), Sumirez Resin SPI-106N (product of Sumitomo Chemical), Sumirez Resin SPI-203(50) (product of Sumitomo Chemical), Sumirez Resin SPI-198 (product of Sumitomo Chemical), Printive A-700 (product of Asahi Kasei), Printive A-600 (product of Asahi Kasei), PA6500 (product of Seiko PMC), PA6504 (product of Seiko PMC), PA6634 (product of Seiko PMC), PA6638 (product of Seiko PMC), PA6640 (product of Seiko PMC), PA6644 (product of Seiko PMC), PA6646 (product of Seiko PMC), PA6654 (product of Seiko PMC), PA6702 (product of Seiko PMC), PA6704 (product of Seiko PMC) or CP8994 (product of Seiko PMC) can be mentioned.

In the present invention, there is no special limitation in combination of above mentioned binder and crosslinking agent, however, combinations of polyvinyl alcohol or derivatives thereof with boric acid or borax, carboxyl denatured PVA with polyamide epichlorohydrine, polyvinyl alcohol or derivatives thereof with melamine resin, carboxyl denatured PVA with polyamide epichlorohydrine and melamine resins, or carboxyl denatured PVA with polyamide epichlorohydrine with polyamide epichlorohydrine and polyamine/amide are desirable. Especially, by together use of carboxyl denatured polyvinyl alcohol as a binder, epichlorohydrine resins and denatured polyamine/amide resins as crosslinking agent, a thermally sensitive recording medium having excellent quality can be obtained.

The reason why excellent effect can be obtained by together use of above mentioned carboxyl denatured polyvinyl alcohol, epichlorohydrine resins and denatured polyamine/amide resins as a crosslinking agent can be considered as follows.

That is, in a protect layer of the thermally sensitive recording medium of the present invention, a carboxyl group of carboxy denatured polyvinyl alcohol and amine or amide part of epichlorohydrine resins, which is a crosslinking agent, cause crosslinking reaction and displays preliminary water resistance. Then, denatured polyamine/amide resins, which possesses many hydrophobic group, provides secondary water resistance to protect a crosslinked part formed by denatured polyvinyl alcohol and epichlorohydrine resins from water by a hydrophobic group. That is, it is considered that the good water resistance is obtained by providing excellent hydrophobic effect to the crosslinked part formed by carboxyl denatured polyvinyl alcohol and epichlorohydrine resins by function of denatured polyamine/amide resins. Further, denatured polyamine/amide resin itself, which is cationic, causes false crosslinking reaction with carboxylic group of carboxy denatured polyvinyl alcohol, accordingly, by the effect of the reaction, good water resistance is realized. Further, denatured polyamine/amide resins itself, which is cationic, causes false bridgeable reaction with a carboxyl group of carboxy denatured polyvinyl alcohol, and by the effect of this reaction, good water resistance is also realized.

The amount of a binder and a crosslinking agent are decided according to the required feature and recording aptitude and not restricted, however, in general, sufficient amount to display its ability is from 1 to 100 parts to 100 parts of ordinary binder. And the coating amount of coating liquid which forms an over coating layer is not restricted, however, when the amount is less than 0.1 g/m², desired effect to the present invention can not be displayed sufficiently and when is over than 10 g/m², the recording sensitivity of the thermally sensitive recording medium will be deteriorated remarkably. Therefore, the coating amount is generally 1-10 g/m² and desirably is adjusted within the range of 0.5-10 g/m² by dry weight. Coating liquid to form an over coating layer is generally prepared as an aqueous coating liquid, that is, mixed and dispersed well by a mixing stirred such as mixer, attriter, ball mill or roll mill accorsing to the needs, then is coated over thermally sensitive recording layer.

As an electron accepting color developing agent used in the present invention, all public known color developing agents in conventional pressure sensitive or thermally sensitive recording paper fields can be used and not especially restricted, however, for example, inorganic acidic compound such as activated clay, attapulgite, colloidal silica or aluminum silicate, 4,4′-isopropylidenediphenol, 1,1-bis(4-hydroxyphenyl)cyclohexane, 2,2-bis(4-hydroxyphenyl)-4-methylpentane, 4,4′-dihydroxydiphenylsulfide, hydroquinonemonobenzylether, 4-hydroxybenzylbenzoate, 4,4′-dihydroxydiphenylsulfone, 2,4′-dihydroxydiphenylsulfone, 4-hydroxy-4′-isopropoxydiphenylsulfone, 4-hydroxy-4′-n-propoxydiphenylsulfone, bis(3-allyl-4-hydroxyphenyl)sulfone, 4-hydroxy-4′-methyldiphenylsulfone, 4-hydroxyphenyl-4′-benzyloxyphenylsulfone, 3,4-dihydroxyphenyl-4′-methylphenylsulfone, aminobenzenesulfoamide derivatives disclosed in JPH8-59603A publication, bis(4-hydroxyphenylthioethoxy)methane, 1,5-di(4-hydroxyphenylthio)-3-oxapentane, bis(p-hydroxyphenyl)butylacetate, bis(p-hydroxyphenyl)methylacetate, 1,1-bis(4-hydroxyphenyl)-1-phenylethane, 1,4-bis[α-methyl-α-(4′-hydroxyphenyl)ethyl]benzene, 1,3-bis[α-methyl-α-(4′-hydroxyphenyl)ethyl]benzene, di(4-hydroxy-3-methylphenyl)sulfide, 2,2′-thiobis(3-tert-octylphenol), 2,2′-thiobis(4-tert-octylphenol), phenolic compound such as diphenylsulfone crosslinked compound disclosed in WO97/16420 International Publication, compound disclosed in WO02/081229 International Publication or JP2002-301873 A publication, thiourea compound such as N,N′-di-m-chlorophenylthiourea, thiourea compounds such as p-chlorobenzoic acid, stearyl gallate, bis[4-(n-octyloxycabonylamino)zincsalicylate]di-hydrate, aromatic carboxylic acid such as 4-[2-(p-methoxyphenoxy)ethyloxy]salicylic acid, 4-[3-(p-tolylsulfonyl)propyloxy]salicylic acid or 5-[p-(2-p-p-methoxyphenoxyethoxycumyl)salicylic acid, and salt of these aromatic acids with divalent metal such as zinc, magnesium, aluminium, calcium, titanium, manganese, thin or nickel, antipyrine complex of zinc thiocyanate, complex zinc salt of terephthalaldehydic and other aromatic carboxylic acid can be mentioned. These color developing agents can be used alone or together with. Diphenylsulfone crosslinking compound can be purchased as D-90, which is a product of Nihon Soda. Further, the compound disclosed in WO02/081229 International Publication can be purchased as commodity name D-100 of Nihon Soda. Still further, it is possible to contain metal chelete color developing component such as higher fatty acid metal complex salt disclosed in JP H10-258577 A publication or divalent hydroxyl aromatic compounds.

As an electron donating leuco dye used in the present invention, any kinds of dye which are public known in fields of pressure sensitive of thermally sensitive recording medium can be used and not restricted, and for example, triphenylmethane compounds, fluorane, fluorene or divinyl compounds are desirably used. Examples of specific colorless or pale colored dye (dye precursor) are shown as follows. These dye precursors can be used alone or together with.

### <Triphenyl Methane Leuco Dyes>

3,3-bis(p-dimethylaminophenyl)-6-dimethylaminophthalide [another name; Crystal Violet Lacton],
3,3-bis(p-dimethylaminophenyl)phthalide [another name is Malachite Green Lactone]

### <Fluorane Leuco Dyes>

3-diethylamino-6-methylfluorane
3-diethylamino-6-methyl-7-anilinofluorane
3-diethylamino-6-methyl-7-(o,p-dimethylanilino)fluorane
3-diethylamino-6-methyl-7-chlorofluorane
3-diethylamino-6-methyl-7-(m-trifluoromethylanilino)fluorane
3-diethylamino-6-methyl-7-(o-chloroanilino)fluorane
3-diethylamino-6-methyl-7-(p-chloroanilino)fluorane
3-diethylamino-6-methyl-7-(o-fluoroanilino)fluorane
3-diethylamino-6-methyl-7-(m-methylanilino)fluorane
3-diethylamino-6-methyl-7-n-octylanilinofluorane
3-diethylamino-6-methyl-7-n-octylaminofluorane
3-diethylamino-6-methyl-7-benzylaminofluorane
3-diethylamino-6-methyl-7-dibenzylaminofluorane
3-diethylamino-6-chloro-7-methylfluorane
3-diethylamino-6-chloro-7-anilinofluorane
3-diethylamino-6-chloro-7-p-methylanilinofluorane
3-diethylamino-6-ethoxyethyl-7-anilinofluorane
3-diethylamino-7-methylfluorane
3-diethylamino-7-chlorofluorane
3-diethylamino-7-(m-trifluoromethylanilino)fluorane
3-diethylamino-7-(o-chloroanilino)fluorane
3-diethylamino-7-(p-chloroanilino)fluorane
3-diethylamino-7-(o-fluoroanilino)fluorane
3-diethylamino-benzo[a]fluorane
3-diethylamino-benzo[c]fluorane
3-dibutylamino-6-methyl-fluorane
3-dibutylamino-6-methyl-7-anilinofluorane
3-dibutylamino-6-methyl-7-(o,p-dimethylanilino)fluorane
3-dibutylamino-6-methyl-7-(o-chloroanilino)fluorane
3-dibutylamino-6-methyl-7-(p-chloroanilino)fluorane
3-dibutylamino-6-methyl-7-(o-fluoroanilino)fluorane
3-dibutylamino-6-methyl-7-(m-trifluoromethylanilino)fluorane
3-dibutylamino-6-methyl-chlorofluorane
3-dibutylamino-6-ethoxyethyl-7-anilinofluorane
3-dibutylamino-6-chloro-7-anilinofluorane
3-dibutylamino-6-methyl-7-p-methylanilinofluorane
3-dibutylamino-7-(o-chloroanilino)fluorane
3-dibutylamino-7-(o-fluoroanilino)fluorane
3-di-n-pentylamino-6-methyl-7-anilinofluorane
3-di-n-pentylamino-6-methyl-7-(p-chloroanilino)fluorane
3-di-n-pentylamino-7-(m-trifluoromethylaniliono)fluorane
3-di-n-pentylamino-6-chloro-7-anilinofluorane
3-di-n-pentylamino-7-(p-chloroanilino)fluorane
3-pyrrolidino-6-methyl-7-anilinofluorane
3-piperidino-6-methyl-7-anilinofluorane
3-(N-methyl-N-propylamino)-6-methyl-7-anilinofluorane
3-(N-methyl-N-cyclohexylamino)-6-methyl-7-anilinofluorane
3-(N-ethyl-N-cyclohexylamino)-6-methyl-7-anilinofluorane
3-(N-ethyl-N-xylamino)-6-methyl-7-(p-chloroanilino)fluorane
3-(N-ethyl-p-toluidino)-6-methyl-7-anilinofluorane
3-(N-ethyl-N-isoamylamino)-6-methyl-7-anilinofluorane
3-(N-ethyl-N-isoamylamino)-6-chloro-7-anilinofluorane
3-(N-ethyl-N-tetrahydrofurfurylamino)-6-methyl-7-anilinofluorane
3-(N-ethyl-N-isobutylamino)-6-methyl-7-anilinofluorane
3-(N-ethyl-N-ethoxypropylamino)-6-methyl-7-anilinofluorane
3-cyclohexylamino-6-chlorofluorane
2-(4-oxahexyl)-3-dimethylamino-6-methyl-7-anilinofluorane
2-(4-oxahexyl)-3-diethylamino-6-methyl-7-anilinofluorane
2-(4-oxahexyl)-3-dipropylamino-6-methyl-7-anilinofluorane
2-methyl-6-p-(p-dimethylaminophenyl)aminoanilinofluorane
2-methoxy-6-p-(p-dimethylaminophenyl)aminoanilinofluorane
2-chloro-3-methyl-6-p-(p-phenylaminophenyl)aminoanilinofluorane
2-chloro-6-p-(p-dimethylaminophenyl)aminoanilinofluorane
2-nitro-6-p-(p-diethylaminophenyl)aminoanilinofluorane
2-amino-6-p-(p-diethylaminophenyl)aminoanilinofluorane
2-diethylamino-6-p-(p-diethylaminophenyl)aminoanilinofluorane
2-phenyl-6-methyl-6-p-(p-phenylaminophenyl)aminoanilinofluorane
2-benzyl-6-p-(p-phenylaminophenyl)aminoanilinofluorane
2-hydroxy-6-p-(p-phenylaminophenyl)aminoanilinofluorane
3-methyl-6-p-(p-dimethylaminophenyl)aminoanilinofluorane
3-diethylamino-6-p-(p-diethylaminophenyl)aminoanilinofluorane
3-diethylamino-6-p-(p-dibutylaminophenyl)aminoanilinofluorane
2,4-dimethyl-6-[(4-dimethylamino)anilino]-fluorane

### <Fluorene Leuco Dyes>

3,6,6′-tris(dimethylamino)spiro[fluorene-9,3′-phthalide]
3,6,6′-tris(diethylamino)spiro[fluorene-9,3′-phthalide]

### <Divinyl Leuco Dyes>

3,3-bis-[2-(p-dimethylaminophenyl)-2-(p-methoxyphenyl)ethenyl]-4,5,6,7-tetrabromophthalide
3,3-bis-[2-(p-dimethylaminophenyl)-2-(p-methoxyphenyl)ethenyl]-4,5,6,7-tetrachlorophthalide
3,3-bis-[1,1-bis(4-pyrrolidinophenyl)ethylene-2-yl]-4,5,6,7-tetrabromophthalide
3,3-bis-[1-(4-methoxyphenyl)-1-(4-pyrrolidinophenyl)ethylene-2-yl]-4,5,6,7-tetrachlorophthalide

### <Others>

3-(4-diethylamino-2-ethoxyphenyl)-3-(1-ethyl-2-methylindol-3-yl)-4-azaphthalide
3-(4-diethylamino-2-ethoxyphenyl)-3-(1-octyl-2-methylindol-3-yl)-4-azaphthalide
3-(4-cyclohexylethylamino-2-methoxyphenyl)-3-(1-ethyl-2-methylindol-3-yl)-4-azaphthalide
3,3-bis(1-ethyl-2-methylindol-3-yl)phthalide
3,6-bis(diethylamino)fluorane-γ-(3′-nitro)anilinolactam
3,6-bis(diethylamino)fluorane-γ-(4′-nitro)anilinolactam
1,1-bis-[2′,2′,2″,2″-tetrakis-(p-dimethylaminophenyl)-ethenyl]-2,2-dinitrilethane
1,1-bis-[2′,2′,2″,2″-tetrakis-(p-dimethylaminophenyl)-ethenyl]-2-β-naphthoyl ethane
1,1-bis-[2′,2′,2″,2″-tetrakis-(p-dimethylaminophenyl)-ethenyl]-2,2-diacetylethane
bis-[2,2,2′,2′-tetrakis-(p-dimethylaminophenyl)-ethenyl]-methylmalonic acid dimethyl ester.

Further, in the present invention, conventional sensitizer can be used in the range not obstructing the desired effect regarding above mentioned object of the present invention. As the specific example of the sensitizer, ethylenebisfattyacidamide, fatty acid monoamide, montan wax, polyethylene wax, 1,2-di(3-methylphenoxy)ethane, p-benzylbiphenyl, β-benzyloxynaphthalene, 4-biphenyl-p-tolyl ether, m-terphenyl, 1,2-diphenoxyethane, 4,4′-ethylenedioxy-bis-dibenzyl dibenzoate, dibenzoyloxymethane, 1,2-di(3-methylphenoxy)ethylene, 1,2-diphenoxyethylene, bis[2-(4-methoxy-phenoxy)ethyl]ether, methyl p-nitrobenzoate, dibenzyloxalate, di(p-chlorobenzyl)oxalate, di(p-methylbenzyl)oxalate, dibenzylterephthalate, benzyl p-benzyloxybenzoate, di-p-tolylcarbonate, phenyl-α-naphythylcarbonate, 1,4-diethoxynaphthalene, phenyl 1-hydroxy-2-naphthoate, 4-(m-methyl phenoxymethyl)biphenyl, orthotoluenesulfonamide and paratoluenesulfonamide, however, not intending to be limited to these compounds. These sensitizers can be used alone or can be used together with.

As a filler to be used in the present invention, an inorganic filler such as silica, calcium carbonate, kaolin, calcined kaolin, diatomaceous earth, talk, titanium oxide or aluminum hydroxide or an organic filler can be mentioned. Further, a slipping agent such as waxes, an U.V. ray absorbing agent, a dispersing agent, a defoaming agent, an antioxidant or a fluorescent dye can be used.

Furthermore, in the present invention, a stabilizer which displays oil repellent effect to the recorded image can be used in the range not obstructing the desired effect regarding above mentioned object of the present invention. As the specific example of the stabilizer, 4,4′-buthylidenebis(6-t-butyl-3-methylphenol), 2,2′-di-t-butyl-5,5′-dimethyl-4,4′-sulphonyldiphenol, 1,1,3-tris(2-methyl-4-hydroxy-5-cyclohexylphenyl)butane, 1,1,3-tris(2-methyl-4-hydroxy-5-t-butylphenyl)butane, 4-benzyloxy-4′-(2,3-epoxy-2-methylpropoxy)diphenylsulfone or epoxy resin can be added.

The kinds and amount of basic leuco dye, color developing agent and other components which are used in the thermally sensitive recording medium of the present invention, are decided according to the required properties and recording aptitude and not restricted, however, ordinary, 0.5 to 10 parts of color developing agent and 0.5 to 10 parts of sensitizer to 1 part of basic leuco dye are used.

The subjected thermally sensitive recording medium can be obtained by applying the coating composed of above mentioned composition on a desired substrate such as paper, recycled paper, synthetic paper, film, plastic film, plastic foam film or non-woven cloth. And a composite sheet which is prepared by combining these substrates can be used as a substrate too.

Basic leuco dye, color developing agent and other materials to be added by necessity are ground by a ball mill, an attriter or a sand grinder, or by means of an adequate emulsifying apparatus, until they are ground under several micron size, then add various additives according to the object and prepare a coating. Regarding coating layers except under coating layer, the means for application is not restricted and public known conventional methods can be used, for example, an off machine coater with various coater such as air knife coater, blade coating, short dwell coating, curtain coating or dye coating, or an on machine coater can be voluntarily chosen and used. The coating amount for a thermally sensitive layer is not specifically restricted, however, in general, is in the range from 2 to 12 g/m² by dry weight.

For the purpose to enhance the color developing sensitivity, the thermally sensitive recording medium can provide an under coating layer of polymer containing filler under a thermally sensitive recording layer. And can provide a back coating layer on the opposite side of the substrate to which the thermally sensitive recording layer is provided, for the purpose to correct the curling of the sheet. Further, various public known technique in the field of thermally sensitive recording medium, such as smoothing treatment after coating of each layer, for example, super calendaring can be carried out.

### EXAMPLE

The thermally sensitive recording medium of the present invention will be illustrated more actually according to the Examples. In illustration, “parts” and “%” indicates “weight parts” and “weight %”.

### Example 1

Blended compounds composed of following components are stirred and dispersed and prepare a coating for under coating layer.

### U Solution (Coating Liquid for Under Coating Layer)

| | |
|---|---|
| Calcined Kaolin (product of Engelhard, commodity name: | 100 parts |
| Ansilex 90, <oil absorbing amount 90 cc/100 g>) | |
| Styrene•butadiene copolymer latex (solid part 48%) | 40 parts |
| Polyvinyl alcohol 10% aqueous solution | 30 parts |
| Water | 146 parts |

After applying the coating liquid for under coating layer on one surface of a substrate (paper of 50 g/m²) by blade coating method, dried and a coating paper with under coating layer of dry coating amount of 10.0 g/m² is obtained.

Dispersion of color developing agent (A solution), dispersion of leuco dye (B solution) and dispersion of sensitizer (C solution) of following composition are ground separately by a sand grinder in wet condition so as to the average particle size becomes 0.5 micron.

A solution (dispersion of color developing agent)

| | |
|---|---|
| 4-hydroxy-4′-isopropoxydiphenylsulfone | 6.0 parts |
| Polyvinyl alcohol 10% aqueous solution | 18.8 parts |
| Water | 11.2 parts |

B solution (leuco dye dispersion)

| | |
|---|---|
| 3-dibutylamino-6-methyl-7-anilinofluorane (ODB-2) | 2.0 parts |
| 10% aqueous solution of polyvinyl alcohol | 4.6 parts |
| Water | 2.6 parts |

C solution (dispersion of sensitizer)

| | |
|---|---|
| Dibenzyl oxalate | 6.0 parts |
| 10% aqueous solution of polyvinyl alcohol | 18.8 parts |
| Water | 11.2 parts |

Then dispersions are mixed by following ratio and a coating for thermally sensitive layer is obtained.

Coating for thermally sensitive layer

| | |
|---|---|
| A solution (dispersion of color developing agent) | 36.0 parts |
| B solution (leuco dye dispersion) | 13.8 parts |
| C solution (dispersion of sensitizer) | 36.0 parts |
| 10% aqueous solution of polyvinyl alcohol | 25 parts |

After applying the coating for thermally sensitive recording layer on an under coating layer of the paper for under coating layer to be applied, then dried and a coating paper for thermally sensitive layer coating of coating amount of 6.0 g/m² is obtained.

Then mixed by following ratio and a coating for an over coating layer is obtained.

Coating containing a binder

| | |
|---|---|
| Aluminum hydroxide (50% dispersion) | 6.0 parts |
| 10% aqueous solution of polyvinyl alcohol | 30 parts |
| Zinc stearate (commodity name: Hydrine Z-7-30, solid part | 1.7 parts |
| 30%, particle 5.5 micron; product of CYUKYO Yushi) | |

Coating containing crosslinking agent

| | |
|---|---|
| Boric acid (solid parts 5%) | 20 parts |
| Acetylene gricol | 0.05 parts |

After 0.1 second from applying a binder containing coating on the thermally sensitive recording layer of the paper for coating of thermally sensitive recording layer by curtain coating method so as the dry coating amount to be 1.7 g/m² without having drying process between, coating containing crosslinking agent is applied so as the dry coating amount to be 0.3 g/m², then dried, and treated the sheet so as the smoothness of the sheet to be 1000-2000 seconds by a super calendar and a thermally sensitive recording medium is obtained. While, distance between films and applying speed are mentioned as follows.

Distance between curtain films: 1.0 meter

Applying speed: 600 m/min

### Example 2

A thermally sensitive recording medium is prepared by same process to Example 1 except applying the coating containing a crosslinking agent of Example 1 after 0.5 minute from applying the coating containing a binder of Example 1 by a curtain coating method without having a drying process between. While, distance between films and applying speed are mentioned as follows.

Distance between curtain films: 5 m

Applying speed: 600 m/min

### Example 3

A thermally sensitive recording medium is prepared by same process to Example 1 except applying the coating containing a crosslinking agent of Example 1 after 4.0 minute from applying the coating containing a binder of Example 1 by a curtain coating method without having a drying process between. While, distance between films and applying speed are mentioned as follows.

Distance between curtain films: 10 m

Applying speed: 150 m/min

### Example 4

A thermally sensitive recording medium is prepared by same process to Example 1 except applying the coating containing a crosslinking agent of Example 1 after 3.0×10⁻² minute from applying the coating containing a binder of Example 1 by a curtain coating method without having a drying process between. While, distance between films and applying speed are mentioned as follows.

Distance between curtain films: 0.3 m

Applying speed: 600 m/min

### Example 5

A thermally sensitive recording medium is prepared by same process to Example 1 except applying the coating containing a crosslinking agent of Example 1 after 3.0×10⁻³ minute from applying the coating containing a binder of Example 1 by a curtain coating method without having a drying process between. While, distance between films and applying speed are mentioned as follows.

Distance between curtain films: 0.3 m

Applying speed: 600 m/min

### Example 6

After 0.1 second from applying a coating containing a crosslinking agent of Example 1 on the thermally sensitive recording layer of the paper for coating of thermally sensitive recording layer of Example 1 by curtain coating method so as the dry coating amount to be 0.3 g/m² without having drying process between, coating containing a binder is applied so as the dry coating amount to be 1.7 g/m², then dried, and the sheet is treated so as the smoothness of the sheet to be 1000-2000 seconds by a super calendar and a thermally sensitive recording medium is obtained.

### Example 7

A thermally sensitive recording medium is prepared by same process to Example 6 except applying the coating containing a binder by curtain coating method after 1.0 second from applying a coating containing a crosslinking agent of Example 1 by curtain coating method without having drying process between.

### Example 8

A thermally sensitive recording medium is prepared by same process to Example 1 except boric acid of a crosslinking agent of Example 6 to melamine compound solution (Sumirez Resin 613 (solid part; 60%) product of Sumitomo Chemical).

### Example 9

A thermally sensitive recording medium is prepared by same process to Example 1 except boric acid of a crosslinking agent of Example 1 to melamine compound solution (Sumirez Resin 613S (solid part; 60%) product of Sumitomo Chemical).

### Example 10

A thermally sensitive recording medium is prepared by same process to Example 1 except boric acid of a crosslinking agent of Example 1 to polyammideepichlorohydrine compound (WS4020 (solid part 40%) product of Seiko PMC).

### Example 11

A thermally sensitive recording medium is prepared by same process to Example 6 except boric acid of a crosslinking agent of Example 6 to polyammideepichlorohydrine compound (WS4020 (solid part 40%) product of Seiko PMC).

### Example 12

A thermally sensitive recording medium is prepared by same process to Example 1 except applying a coating containing a crosslinking agent after 6 seconds from applying a coating containing a binder without having drying process between. While, distance between films and applying speed are mentioned as follows.

Distance between curtain films: 10 m

Applying speed: 100 m/min

### Comparative Example 1

Coating liquid for under layer coating part and coating liquid for upper layer coating part are mixed with afore mentioned parts and the mixed coating liquid is applied on the thermally sensitive recording layer of the paper for coating of thermally sensitive recording layer by slide curtain coating method so as the dry coating amount to be 2.0 g/m², then dried, and the sheet is treated so as the smoothness of the sheet to be 1000-2000 seconds by a super calendar and a thermally sensitive recording medium is obtained. While, the applying speed is set up as follows.

Applying speed: 600 m/min

### Comparative Example 2

A thermally sensitive recording medium is prepared by same process to Example 1 except a coating containing a crosslinking agent of Example 1 to a coating containing a binder.

### Comparative Example 3

A thermally sensitive recording medium is obtained by applying (curtain coating) a coating containing a binder of Example 1 and drying, after that a coating containing a crosslinking agent is applied on it and dried. While, the applying speed of a coating containing a binder and a coating containing a crosslinking agent are set up as follows.

Coating containing a binder: 600 m/min

Coating containing a crosslinking agent: 600 m/min

Following evaluation tests are carried out on specimens of thermally sensitive recording media obtained in Examples and Comparative Examples and results are summarized in Table 1.

### [Printing Aptitude]

RI printing is carried out on the surface of a thermally sensitive recording medium by UV ink and coming off of ink is measured by eyes of an operator and evaluated by following standard.

◯: coming off of ink is not observed

Δ: coming off of ink is observed slightly

×: many coming off of ink are observed

### [Barrier Ability]

A letter is written on the surface of the thermally sensitive recording medium by an oily marker pen (dry ink No. 500), then the recording state of the letter is measured by eye inspection and evaluated by following standard.

### <Oily Maker Pen>

◯: no blotting, can be practically used

Δ: blotting is observed, slightly problem for practical use

×: remarkable blotting is observed, problem for practical use

### [Color Developing Sensitivity]

The produced thermally sensitive recording medium was subjected to printing at an applied energy of 0.34 mJ/dot using TH-PMD. Image densities are measured by a Macbeth Densitometer (using an amber filter).

### [Water Resistance]

One water drop is dropped on the surface of a thermally sensitive layer, after 10 minutes time lapse, scrubbed by a tissue paper, and removing of a recording surface is measured by eyes of an inspector and evaluated by following standard.

⊚: no removal in a recorded surface

◯: nearly no removal in a recorded surface

Δ: removal of recorded surface is observed slightly

×: many removals are observed

TABLE 1

| | substrate | surface | time | printing | barrier | printing | water | |
|---|---|---|---|---|---|---|---|---|
| | side | side | (sec) | aptitude | ability | density | resistance | Remarks |
| Example 1 | boric acid | PVA | 0.1 | ◯ | ◯ | 1.36 | ◯ | |
| Example 2 | boric acid | PVA | 0.5 | ◯ | ◯ | 1.34 | ◯ | |
| Example 3 | boric acid | PVA | 4 | ◯ | ◯ | 1.31 | Δ | |
| Example 4 | boric acid | PVA | 0.03 | ◯ | ◯ | 1.31 | ⊚ | |
| Example 5 | boric acid | PVA | 0.003 | ◯ | ◯ | 1.35 | ⊚ | |
| Example 6 | PVA | boric acid | 0.1 | ◯ | ◯ | 1.35 | ◯ | |
| Example 7 | PVA | boric acid | 1 | ◯ | ◯ | 1.35 | ◯ | |
| Example 8 | PVA | melamine | 0.1 | ◯ | ◯ | 1.34 | ◯ | |
| Example 9 | melamine | PVA | 0.1 | ◯ | ◯ | 1.35 | ◯ | |
| Example 10 | PVA | PAE | 0.1 | ◯ | ◯ | 1.34 | ◯ | |
| Example 11 | PAE | PVA | 0.1 | ◯ | ◯ | 1.34 | ◯ | |
| Example 12 | boric acid | PVA | 5 | Δ | Δ | 1.28 | Δ | |
| Comparative | PVA + | — | — | X | X | 1.31 | X | single layer |
| Example 1 | boric acid | | | | | | | coating |
| Comparative | PVA | PVA | 0.1 | X | X | 1.33 | X | |
| Example 2 | | | | | | | | |
| Comparative | boric acid | PVA | — | Δ | Δ | 1.36 | Δ | with drying |
| Example 3 | | | | | | | | process |

### INDUSTRIAL APPLICABILITY

A thermally sensitive recording medium possessing a coating layer formed by applying a coating (A) containing a binder and a coating (B) containing a crosslinking agent on a thermally sensitive layer, forming an over coating layer by applying the coating (A) and the coating (B) separately by curtain coating method, wherein the preparation of said over coating layer is comprising, after applying one coating, applying another coating by curtain coating method without having a drying process between, by the thermally sensitive recording medium, quality superior in writing aptitude and printing aptitude and excellent in preserving stability of developed image to head debris, water resistance, sticking, and to nature environment such as water, humid or light, to sebum, when handled with hand, oils, plasticizers and solvents.

1. A method for preparation of a thermally sensitive recording medium possessing a coating layer formed by applying a coating (A) containing a binder and a coating (B) containing a crosslinking agent on a thermally sensitive recording layer, which is formed on a substrate, and said thermally sensitive recording layer contains a colorless or pale colored electron donating leuco dye and an electron accepting color developing agent comprising, forming an over coating layer by applying said coating (A) and coating (B) separately in accordance with a curtain coating method, wherein the formation of the over coating layer is comprising, after applying one coating, applying another coating in accordance with a curtain coating method without having a drying process between.

2. A method for preparation of a thermally sensitive recording medium possessing a coating layer formed by applying a coating (A) containing a binder and a coating (B) containing a crosslinking agent on a thermally sensitive recording layer, which is formed on a substrate, and said thermally sensitive recording layer contains a colorless or pale colored electron donating leuco dye and an electron accepting color developing agent comprising, forming an over coating layer by applying said coating (A) and coating (B) separately in accordance with a curtain coating method, wherein the formation of the over coating layer is comprising, after applying one coating, applying another coating in accordance with a curtain coating method within 1.0×10⁻⁴ seconds or more and shorter than 5.0 seconds without having a drying process between.

3. The thermally sensitive recording medium and the method for preparation thereof of claim 1, wherein a coating containing a binder is applied by a curtain coating method after a coating (B) containing a crosslinking agent is applied by a curtain coating method.

4. The thermally sensitive recording medium and the method for preparation thereof of claim 1, wherein a coating containing a crosslinking agent is applied by a curtain coating method after a coating (A) containing a binder is applied by a curtain coating method.

5. The thermally sensitive recording medium and the method for preparation thereof according to claim 1, wherein the binder possesses hydroxyl group and/or carboxyl group.

6. The method for preparation of the thermally sensitive recording medium according to claim 1, wherein the crosslinking agent is at least one selected from the group consisting of boron compounds, melamine compounds, epichlorohydrine compounds, aldehyde compounds, denatured polyamine and amide compounds.
